(19) United States
(12) Patent Application Publication
(10) Pub. No.: US 2022/0398341 A1
(43) Pub. Date: Dec. 15, 2022

(54) DIGITAL PLATFORM FOR COMMUNITY-BASED PRIVACY-PRESERVING DATA SCIENCE

(71) Applicant: BOWHEAD HEALTH, INC., Kanata (CA)

(72) Inventors: Francisco Diaz-Mitoma, Santa Monica, CA (US); César Alberto Díaz Hermosillo, Guadalajara (MX)

(21) Appl. No.: 17/837,828

(22) Filed: Jun. 10, 2022

Related U.S. Application Data
(60) Provisional application No. 63/209,946, filed on Jun. 11, 2021.

(51) Int. Cl. G06F 21/62; G06F 21/60

(52) U.S. Cl. CPC G06F 21/6245; G06F 21/602

(57) ABSTRACT

Described are various embodiments of a digital platform for community-based privacy-preserving data science.

### FIELD OF THE DISCLOSURE

The present disclosure relates to data science, and, in particular, to a digital platform for community-based privacy-preserving data science.

### BACKGROUND

The notion of “big data” has become ubiquitous in modern society as a means of understanding phenomena and predicting outcomes based on artificial intelligence and/or data science models. For instance, the generation of accurate machine learning models is encouraged through community-based platforms such as Kaggle™, wherein data scientists may submit data models for evaluation on training data sets for a plethora of applications.

However, for good reason, access to data is not always unfettered. For instance, while many institutions acquire enormous amounts of health-related data on many patients, such data is by nature highly sensitive, and is accordingly siloed within respective databases to which external parties have limited to no access. As a result, health science model training is typically performed on limited datasets, ultimately reducing the generality and applicably of resultant models.

Various data science processes and systems have been developed in an attempt to preserve the private nature of sensitive data. For instance, OpenMined™ is a publicly accessible digital platform that offers the ability to perform computations on private datasets remotely, while returning from model execution only obfuscated data such that anonymity is preserved. Similarly, the Owkin™ and Apheris™ platforms enable data science model submission and execution in accordance with federated, privacy-preserving learning processes.

Blockchain technology has also recently been widely recognised as a means of encrypting data and maintain a distributed ledger of transactions. For instance, U.S. Pat. No. 10,185,773 entitled “Systems and Methods of Precision Sharing of Big Data” and issued to Litoiu, et al. on January 22, 2019 discloses a blockchain process for maintaining a distributed ledger of transactions and data related thereto.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a digital platform for community-based privacy-preserving data science that overcomes some of the drawbacks of known techniques, or at least, provides a useful alternative thereto. Some aspects of this disclosure provide examples of such systems and methods.

In accordance with one aspect, there is provided a system for performing incentivised community-based privacy-preserving data science, the system comprising: a host server providing a digital environment for hosting respective data science competitions and configured to receive from each given competition submission entity configurational data related to a given competition configuration, and receive from each respective competition participant a respective encrypted data science model comprising respective computationally-executable instructions; and a privacy-preserving execution engine configured to remotely access private data related to each given competition configuration from a private data source and operable to, for each respective encrypted data science model, encryptically execute the respective computationally-executable instructions on the private data, and return a privacy-preserved result of the encryptically executed computationally-executable instructions in accordance with a designated privacy-preserving process; wherein the host server is further configured to, based at least in part on the privacy-preserved result for each respective encrypted data science model, assess a winning data science model in accordance with the given competition configuration; and encryptically store the winning data science model.

In one embodiment, the private data source comprises an institutional data source comprising private data related to a plurality of individuals.

In one embodiment, the private data source comprises user data submitted in accordance with an encryption process.

In one embodiment, the individual user data is managed via a smart contract.

In one embodiment, the given competition configuration comprises an incentive distributable by the host server.

In one embodiment, the incentive comprises a cryptocurrency.

In one embodiment, the incentive is contributed by the given competition submission entity.

In one embodiment, the incentive is contributed by a third-party organisation.

In one embodiment, at least a portion of the incentive is distributed to one or more of the winning competition participant, the private data source, or the competition submission entity.

In one embodiment, the incentive comprises one or more of a monetary incentive or an access right to the winning model.

In one embodiment, the designated privacy-preserving process comprises a differential privacy process.

In one embodiment, the privacy-preserving execution engine is operable to encryptically execute the respective computationally-executable instructions in accordance with a homomorphic encryption process.

In one embodiment, the privacy-preserving execution engine is operable to encryptically execute the respective computationally-executable instructions in accordance with a multi-party encrypted computation process.

In one embodiment, the given competition configuration comprises model training data.

In one embodiment, the privacy-preserving execution engine is operable to encryptically execute the respective computationally-executable instructions in accordance with a federated learning process.

In one embodiment, the privacy-preserving execution engine is operable to encryptically execute the respective computationally-executable instructions in accordance with an on-device prediction process.

In one embodiment, the system further comprises a digital ledger, wherein the host server is further operable to record transactional data in the digital ledger.

In one embodiment, the private data comprises health data.

In one embodiment, the host server comprises a server network.

In accordance with another aspect, there is provided a system for performing incentivised community-based privacy-preserving data science, the system comprising: a coordination engine governing a digital environment for hosting respective data science competitions across a distributed network of computational machines, wherein said digital environment is configured to receive from each given competition submission entity configurational data related to a given competition configuration, and receive from each respective competition participant a respective data science model comprising respective computationally-executable instructions; a privacy-preserving execution engine configured to remotely access private data related to each said given competition configuration from a private data source, and operable to, for each said respective data science model: encryptically execute said respective computationally-executable instructions on said private data; and return a privacy-preserved result of said encryptically executed computationally-executable instructions in accordance with a designated privacy-preserving process; wherein said coordination engine is further configured to: based at least in part on said privacy-preserved result for each said respective encrypted data science model, assess a winning data science model in accordance with said given competition configuration; and encryptically store said winning data science model.

In one embodiment, the private data source comprises private data related to a plurality of individuals.

In one embodiment, the private data source comprises individual user data submitted in accordance with an encryption process.

In one embodiment, the individual user data is managed via a smart contract.

In one embodiment, the given competition configuration comprises an incentive distributable by said host server.

In one embodiment, the incentive comprises a cryptocurrency.

In one embodiment, the incentive is contributed by said given competition submission entity.

In one embodiment, the incentive is contributed by a third-party organisation.

In one embodiment, at least a portion of said incentive is distributed to one or more of said winning competition participant, said private data source, or said competition submission entity.

In one embodiment, the incentive comprises one or more of a monetary incentive or an access right to said winning model.

In one embodiment, the designated privacy-preserving process comprises a differential privacy process.

In one embodiment, the privacy-preserving execution engine is operable to encryptically execute said respective computationally-executable instructions in accordance with a homomorphic encryption process.

In one embodiment, the privacy-preserving execution engine is operable to encryptically execute said respective computationally-executable instructions in accordance with a multi-party encrypted computation process.

In one embodiment, the given competition configuration comprises model training data.

In one embodiment, the privacy-preserving execution engine is operable to encryptically execute said respective computationally-executable instructions in accordance with a federated learning process.

In one embodiment, the privacy-preserving execution engine is operable to encryptically execute said respective computationally-executable instructions in accordance with an on-device prediction process.

In one embodiment, the system further comprises a distributed ledger, and wherein said coordination engine is further operable to record transactional data in said distributed ledger.

In one embodiment, the private data comprises health data.

In one embodiment, the host server comprises a server network.

In one embodiment, the respective data model comprises a respective encrypted data science model.

In accordance with another aspect, there is provided a computer-implemented method for performing incentivised community-based privacy-preserving data science, the method comprising: receiving from each given competition submission entity configurational data related to a given competition configuration; receiving from each respective competition participant a respective encrypted data science model comprising respective computationally-executable instructions; remotely accessing private data related to each said given competition configuration from a private data source, and, for each said respective encrypted data science model: encryptically executing said respective computationally-executable instructions on said private data; and returning a privacy-preserved result of said encryptically executed computationally-executable instructions in accordance with a designated privacy-preserving process; and based at least in part on said privacy-preserved result for each said respective encrypted data science model, assessing a winning data science model in accordance with said given competition configuration; and encryptically store said winning data science model.

In accordance with another aspect, there is provided a computer-implemented method for performing incentivised community-based privacy-preserving data science, the method comprising: receiving from each given competition submission entity configurational data related to a given competition configuration; receiving from each respective competition participant a respective data science model comprising respective computationally-executable instructions; remotely accessing private data related to each said given competition configuration from a private data source, and, for each said respective data science model: encryptically executing said respective computationally-executable instructions on said private data; and returning a privacy-preserved result of said encryptically executed computationally-executable instructions in accordance with a designated privacy-preserving process; based at least in part on said privacy-preserved result for each said respective encrypted data science model, assessing a winning data science model in accordance with said given competition configuration; and encryptically store said winning data science model.

In one embodiment, the method further comprises encrypting one or more of the respective data science model or the private data.

In one embodiment, the method further comprises encryptically storing transactional data associated with the given competition configuration.

In one embodiment, the method further comprises compensating with an incentive one or more users associated with the given competition configuration based at least in part on the transactional data.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a diagram of exemplary participants and roles within a community-based privacy-preserving data science platform, in accordance with various embodiments;

FIG. 2 is a diagram of an exemplary privacy-preserving data science competition, in accordance with various embodiments;

FIG. 3 is a diagram of exemplary data flow within data science competition, in accordance with various embodiments;

FIG. 4 is a diagram of an exemplary incentivisation schema for a community-based privacy-preserving data science platform, in accordance with various embodiments;

FIGS. 5A to 5D are screenshots of exemplary graphical interfaces representing a digital application in which users may repair and/or maintain an in-game environment by exhibiting healthy real-world behaviour, and submitting data related thereto to a digital health science platform, in accordance with one embodiment;

FIG. 6 is an exemplary dashboard associated with a digital health platform with which a healthcare professional may interact, in accordance with one embodiment;

FIG. 7 is a flow diagram of a process by which a digital health data science platform may promote healthy user behaviour and health monitoring, while simultaneously improving health data collection for data science model generation, in accordance with one embodiment;

FIG. 8 is a diagram of an exemplary secure data flow, in accordance with one embodiment;

FIG. 9 is a flow diagram of an exemplary process by which various exemplary users may participate within an exemplary data science platform, in accordance with one embodiment;

FIG. 10 is an exemplary dashboard from which a user may digitally access various aspects of a digital health data science platform, in accordance with one embodiment;

FIG. 11 is an exemplary dashboard from which a user may configure various aspects of a digital health data science competition, in accordance with one embodiment;

FIG. 12 is an exemplary dashboard for viewing various user-associated competition within a digital health data science platform, in accordance with one embodiment

FIG. 13 is a flow diagram of an exemplary user data input process using a digital mobile application, in accordance with one embodiment; and

FIG. 14 is a schematic of an exemplary dashboard for viewing user contributions within a digital health data science platform, in accordance with one embodiment.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “comprising” as used herein will be understood to mean that the list following is non-exhaustive and may or may not include any other additional suitable items, for example one or more further feature(s), component(s) and/or element(s) as appropriate.

“Big data” is a driving force behind many emerging technologies. However, for many applications, data science using big data may often be hindered by the fact that data is centralised by those who collect it, and that the use or sharing of this data is highly controlled. Accordingly, datasets tend to be fractured between respective institutions associated with the collection of respective datasets, and remain unshared due to intellectual property concerns and/or data protection regulations. This is particularly true for highly sensitive and/or private data, such as financial or heath data. This ultimately hinders the generation of data science models as, while potentially accurate when applied to certain use cases, models tend to lack generality and to perform poorly for broader applications due to limited training sets.

While the imposition of restrictions against the access and sharing of private data are important, it may ultimately be in the best interests of humanity for data scientists to have access to all available information to generate the best possible models. This is particularly true for applications such as disease diagnostics and drug development. For example, disease management may be improved through a better understanding of the interplay between genetic variations and disease progression in patients. However, the patient data required to analyse such a relationship may be siloed between different institutions (e.g. a genomics laboratory and a large hospital), wherein no organisation has access to the entirety of available information to develop a well-performing generalised model of disease progression and management. There is therefore a need for a platform for the generation of accurate, generalised data science models that can simultaneously maintain, and adhere to policy and regulations surrounding, data privacy.

The systems and methods described herein provide, in accordance with different embodiments, different examples of such a digital platform for performing privacy-preserving data science on private datasets, such as medical or health-related data. To this end, various embodiments make use of a privacy-preserving computational engine operable to execute digital instructions (e.g. execute data science models on private data) remotely in accordance with a federated learning process, wherein private or sensitive data need never be made public, copied, exchanged, or released from the control of the data owner. Moreover, various embodiments relate to the return of model outcomes (e.g. results of a model evaluation) in a manner that further maintains anonymity and privacy through various privacy-preserving processes, such as that employed by a differential privacy system.

Further, various embodiments relate to a digital platform leveraging a community-based competition format to produce improved data science models. For example, various embodiments relate to customisable competitions in which multiple participants may compete individually or collaboratively to produce health-related models, wherein the generation of a winning model(s) may reward participants with monetary incentives.

Moreover, and in accordance with various embodiments, various aspects of a data science competition may be performed encryptically. For example, similar to how private datasets may be accessed in accordance with a privacy-preserving process, submitted data science models may be encrypted such that the specific calculations performed may be kept secret, thereby ensuring that a data scientist's model remains proprietary such that they may maintain control of a model, or be rewarded for the use thereof.

Indeed, while various embodiments relate to a digital platform for performing data science competitions, various embodiments may further relate to a digital marketplace connecting data scientists and medical researchers with high quality datasets, as well as various organisations in the healthcare industry (e.g. hospitals, life science organisations, public health entities, insurance agencies, and the like) and individual users who may privately contribute health data and receive compensation therefor. For example, a private user submitting health data may receive a monetary compensation for their contribution to a data science model. Alternatively, or additionally, a successful data science model may be licensed by a public health organisation or insurance agency, whereby an individual user contributing biomarker data in accordance with a healthy lifestyle as suggested by the successful model may be rewarded in the form of, for instance, blockchain tokens, cash rewards, or reduced insurance fees. These and other forms of relationships and roles will be described in greater detail below.

Accordingly, throughout this disclosure, various aspects may relate to various computing systems or devices, non-limiting examples of which may include digital platforms, servers, engines, modules, interfaces, clients, portals, digital wallets, or the like. It will be appreciated that such computing systems may comprise at least one digital data processor, such as a CPU, a GPU, a multicore processor, or the like, operable to execute digital instructions stored on, for instance, a non-transitory computer-readable medium, such as a hard drive, a solid-state drive, flash memory, RAM, or the like. Further, it will be appreciated that various processes or other forms of digital instructions may cause a processor to perform or execute process steps as herein described.

Moreover, it will be appreciated that various computing devices may be operable to exchange data in accordance with various information exchange processes known in the art, non-limiting examples of which may include the internet, HTTP, HTTPS, public-private key exchanges, web service APIs, various known query protocols, or the like. Accordingly, it will be understood that various computing devices, such as servers, engines, processors, and the like, may be in networked communication with one another to exchange data, and that data may be exchanged in a secure manner (e.g. encrypted). Such an exchange of data may further be conducted over a packet-switched network, in accordance with various embodiments.

Various aspects of the embodiments herein described may further relate to blockchain technologies, and particularly to the recording of data (e.g. transactional data, raw and/or metadata, or the like) within a blockchain ledger in a distributed and secure fashion. A distributed blockchain may be recorded between peer-to-peer electronic devices as a ledger of transactions or data recorded in a chronological or other order that is suitable for use by the blockchain network. Further, it will be appreciated that data recorded in a blockchain may include raw and/or metadata, a destination address associated with a participant, a currency, such as a non-fungible token (NFC), and/or other fields such that the blockchain may indicate which data and/or how much of such data (e.g. an amount of a currency, a data science model, private data, or the like) is attributable to a specific address and/or participant.

It will further be appreciated that a blockchain technology may comprise an ability to generate and/or maintain a smart contract (e.g. an encrypted data operation performed on a blockchain ledger). For instance, various embodiments herein described relate to, inter alia, transactions made between participants with respect to the exchange of data and/or currency. Indeed, various embodiments relate to the access, usage, and/or exchange of data, including private data. Various aspects of such an ecosystem may be recorded within a blockchain ledger as a smart contract.

It will be appreciated that various blockchain platforms may be employed within the scope and nature of the disclosure. A non-limiting example of such a blockchain platform may include the Bowhead Health™ platform, wherein smart contract technology is employed to securely allow the selective submission and sharing of personal data with another party (e.g. researchers). For instance, and in accordance with some embodiments, a blockchain platform may employ a smart contract protocol to encrypt and decrypt personal health data, while data itself may be stored in an encrypted fashion on an interplanetary file system (IPFS). Similarly, various other forms of data may be encrypted on a blockchain. For example, data science models entered in a data science competition may be encrypted such that specific calculations are kept secret. Such models may additionally, or alternatively, be encrypted within a blockchain so to unequivocally link a particular data science model (e.g. a winning model from a data science competition) with the rightful owner(s), while maintaining the secrecy, and therefore proprietary nature, of a data science model.

While various embodiments relate to a digital platform for performing data science competitions, various embodiments may further relate to a digital marketplace connecting data scientists and medical researchers with high quality datasets, as well as various organisations in the healthcare industry (e.g. hospitals, life science organisations, public health entities, insurance agencies, and the like) and individual users who may privately contribute health data and receive compensation therefor. For example, a private user submitting health data may receive a monetary compensation for their contribution to a data science model. Alternatively, or additionally, a successful data science model may be licensed by a public health organisation or insurance agency, whereby an individual user contributing biomarker data in accordance with a healthy lifestyle as suggested by the successful model may be rewarded in the form of, for instance, blockchain tokens, cash rewards, or reduced insurance fees. In accordance with various embodiments, such a marketplace may be enabled via a blockchain platform such that all proprietary aspects (e.g. data science models, personal health data, and the like) are managed and recorded in a private but reliable fashion, while empowering different participants through the ownership of their respective contributions.

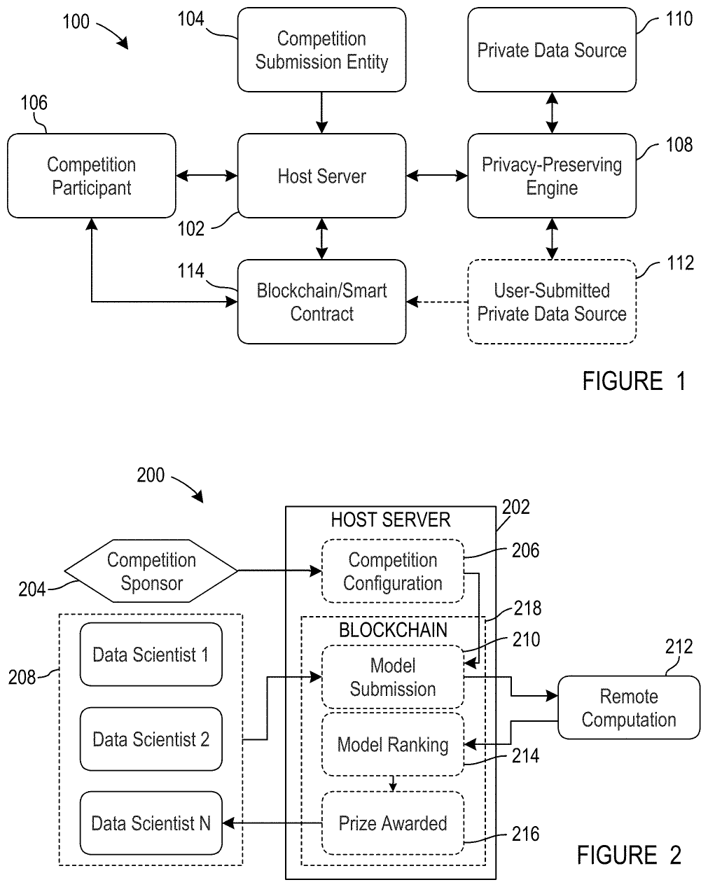

With reference to FIG. 1, and in accordance with one exemplary embodiment, a system for performing incentivised community-based privacy-preserving data science, generally referred to using the numeral 100, will now be described. In this example, the system 100 is generally described with respect to participating entities or roles, including respective human participants, organisations, and computing devices, of a data science competition hosted by a host server 102. In this non-limiting example, the host server 102 may comprise a computing device configured to both provide a digital environment in which the various participating entities may interact, as well as communicate with external systems to achieve various aspects of different embodiments. However, and in accordance with some embodiments, a host server 102 may comprise a server network, and/or a coordination engine related thereto. For example, as various embodiments herein described relate to a decentralised platform employing blockchain technology in one or more aspects of a data science competition, the decentralised platform may further comprise a coordination engine for managing, for instance, data transfer between different participants and/or host servers 102 (or a network thereof). Such a coordination engine may, in accordance with some embodiments, further manage validation of various aspects of a competition, such as smart contract processing or data transfer, to name a few non-limiting examples.

In the exemplary embodiment of FIG. 1, a data science competition may be initiated via the submission to the host server 102 of a competition configuration (e.g. competition format, criteria, training data, or the like) from a competition submission entity 104. The competition submission entity may comprise, for instance, a life science organisation, health insurance company, public health organisation, or the like, seeking to, for instance, further knowledge with respect to a medical condition, to generate improved correlative models between comorbidities, or like aspects related to health and/or data science. Similarly, a submission entity may comprise a pharmaceutical company seeking a data science model to improve drug candidate selection, in accordance with other embodiments.

The host server 102 may then display data related to one or more submitted competitions via a user interface (UI). For example, and in accordance with various embodiments, the UI may display a list of competitions submitted from a plurality of submission entities 104 seeking improved data models for respective health-related applications. Competition participants 106, such as data scientists, may then view the list of competitions and associated rules or criteria via the UI, and download any relevant digital content (e.g. training data sets). Participants 106 may then upload data models to the host server 102 for respective competitions, in accordance with some embodiments. It will be appreciated that the host server 102 may provide further interactive features for various participants, such as discussion boards, challenge leaderboards, or the like.

During a competition or challenge, data science models uploaded to the host server 102 from data scientist participants 106 may then be remotely executed by a privacy-preserving data engine 108 on a private data source 110. A private data source 110 may, in accordance with different embodiments, comprise datasets in turn comprising various forms of digital health-related data, such as electronic medical records (EMRs), medical data (e.g. CT scans, MRIs, X-rays images, ultrasound data, or the like), or the like. Such a repository of private data may be provided by, for instance, one or more hospitals, research institutions, doctors, patients, or the like. In accordance with some embodiments, and as will be further described below, private data 110 may be provided via one or more users, for instance as images and/or survey data provided using a mobile device, wherein such data may be, in some embodiments, encryptically accessed directly via a platform, or as elements of larger and/or conglomerated datasets.

It will be appreciated that such computation may further be performed remotely within a plurality of machines associated with a plurality of private data sources 110. For instance, various research institutions may make respective private data sources 110 available for a data science model computations on a plurality of computational nodes, while data from each source 110 remains in the sole control of the respective institutions or persons with which they are affiliated via, for instance, a federated learning process.

Due to the sensitive nature of such private data, various embodiments relate to the processing of private data in accordance with various privacy-preserving processes. For example, the privacy-preserving engine 108 may analyse private data within a machine(s) associated with the private data source(s) 110, wherein private data need never be copied or otherwise leave the control of its owner. For example, the privacy-preserving engine 108 may employ a federated learning process, whereby a data science model is sent to a remote machine for, for instance, model training on the private data associated with that machine. Accordingly, such analysis may employ an on-device predictive process whereby models are used on a dataset within an application locally on the remote machine, rather than on a machine disassociated from the private data source, such as a cloud.

Further, a privacy-preserving execution engine 108 may return to the host server 102 or owner of a data science model (e.g. competition participant 106) a privacy-preserved result of computations performed remotely (e.g. via a federated learning process) on private data. For example, the privacy-preserving execution engine 108 may return the results of analysis of private data in accordance with a differential privacy or other data-obfuscating protocol, wherein data is only returned such that data points may not be attributable to specific individuals. For example, various techniques may be employed for such differentially private analyses, non-limiting examples of which may include PATE, DP-SDG, Laplace and/or exponential mechanisms, or the like. Further, various embodiments relate to the automatic implementation of such differentially private mechanisms, wherein sufficient noise is automatically added to the private data and/or statistical results of computations such that model outcomes are appropriately obfuscated to maintain privacy.

While various data science competitions may relate to the execution of a data science model submission on private data from an institutional source 110, such as a hospital, various embodiments may additionally, or alternatively, relate to the use of a user-submitted private data source 112 to assess and/or train data science models. For instance, an individual user may have access to a digital application (e.g. a smartphone application, biometric monitoring device, step counter, or the like) via which health-related data may be submitted and/or received by, for instance, the host server 102, or encrypted IPFS associated therewith. For example, a smartphone application may be configured to receive biomarker data related to the user, such as responses to health-related questions (e.g. mood-related questions), nutritional intake, biometric data (e.g. heart rate), activity metrics (e.g. step counts, amount and/or type of exercise), or the like. Similar to institutional and/or big data sources 110, such user-submitted data 112 may be used in a privacy-preserving fashion to train and/or assess health-related data science models in, for instance, a data science competition, as described above.

In accordance with some embodiments, such user data 112 may be submitted in accordance with an encryption protocol so to maintain user privacy. For example, user data may be submitted via a digital application such that the data is encrypted and managed within a blockchain 114 and/or smart contract 114. In this fashion, only authorised entities, such as a privacy-preserving execution engine 108, may access the user-submitted private data 112, a record of which may be similarly recorded. Accordingly, the secrecy of any user-submitted data 112 may be maintained, while also enabling the user to contribute to the improvement of health-related models and empowering the user through the provision of control over who may have access to their personal data.

While various embodiments relate to the submission of data science models via the host server 102, as described above, various embodiments may additionally, or alternatively, relate to the direct interaction of competition participants 106 with a blockchain 114. For example, various embodiments relate to a data science competition platform in which competition participants 106 may submit data science models directly to a blockchain 114. Such embodiments may therefore relate to a platform in which various aspects of a data science competition may be handled by smart contracts 114, such as the management of competition winners and model submissions. Furthermore, competition participants 106 may further interact with a blockchain 114 to, for instance, register user accounts, access respective submitted models, or the like.

It will further be appreciated that, in accordance with some embodiments, a data science competition may be decentralised. For instance, a competition may take place in a distributed manner over a distributed network of nodes. In accordance with yet other embodiments, such nodes may be provided by independent parties, wherein these independent parties may be rewarded for their provision of bandwidth and/or storage as they relate to different data science competitions. It will be appreciated that such participation may further be recorded as and/or within a smart contract 114.

Further, as various embodiments relate to a competition-based format involving many participants (e.g. multiple data scientists 106, private data 112 submitted by users, different organisations within the health science community), such a digital platform provides a community-based approach to data science that, in accordance with various embodiments, may provide improved data science models via collaborative participation between different parties.

With reference now to FIG. 2, and in accordance with various embodiments, an overview of a data science competition, generally referred to with the reference numeral 200, will now be described. In this example, a host server 202 may receive from a competition sponsor 204, such as a government body, public health organisation, or the like, a competition configuration 206. In accordance with various embodiments, a competition sponsor 204 may configure a data science competition (e.g. a tournament, a challenge, or the like) in accordance with a particular goal, a non-limiting example of which may comprise the determination of a predictive machine learning or other artificial intelligence model that accurately assesses a likelihood of a medical condition on a person-by-person basis based on a subset of biomarkers.

A challenge or competition may further be configured via the host server 202 with various competition criteria, instructions, sample datasets, or the like, which may in turn be accessible to any number of competition participants, such as any number of data scientists 208. For example, and as will be further described below, a competition configuration may establish an incentive and/or prize for participants, as defined within competition criteria set forth in the competition configuration 206. A competition configuration 206 may further relate to, for instance, agreements defining the use of any data models or private data submitted for the competition, as will be further described below.

As described above, models 210 submitted to the host server 202 may then be executed remotely 212 on one or more private data sources, the privacy-preserved results of which may then be returned to the host server in accordance with a privacy-preserving protocol (e.g. a differentially private process), in accordance with various embodiments. The host server may then display, via, for instance, a UI, preliminary results of the data model competition. In accordance with some embodiments, results may be presented as, for instance, a competition leaderboard. In continuing with the privacy-preserving nature of the various embodiments herein described, results may be presented such that proprietary aspects of models, or metrics associated with their results, are only visible to respective data model owners.

Upon completion of the competition, the host server 202 may then publish final results 214 in the form of, for instance, a model ranking leaderboard 214. Rankings 214 may be established based on, for instance, the competition configuration 206 as established by the competition sponsor 204. Again based on the competition configuration 206, the competition may then conclude with a winning participant 208 being awarded a prize 216. For instance, a monetary or other prize 216 may be awarded to the data scientist 208 who submits the data science model that, when executed on real, private data, receives the highest score within the scope of the competition configuration 206.

It will be appreciated that, in accordance with various embodiments, one or more aspects of a data science competition 200 may be managed by a blockchain 218. For example, data scientists 208 may submit models 218 for the competition directly via a smart contract, rather than via the host server 202. Similarly, a prize 216 may be awarded to one or more winning participants 208 directly from a blockchain 218. It will be appreciated that such smart contract management may be independent from competition aspects management the host server 202, and/or that different aspects of a data science competition may be managed by one or more of a host server 202 and blockchain 218 depending on, for instance, the nature of a competition and/or a competition configuration 206.

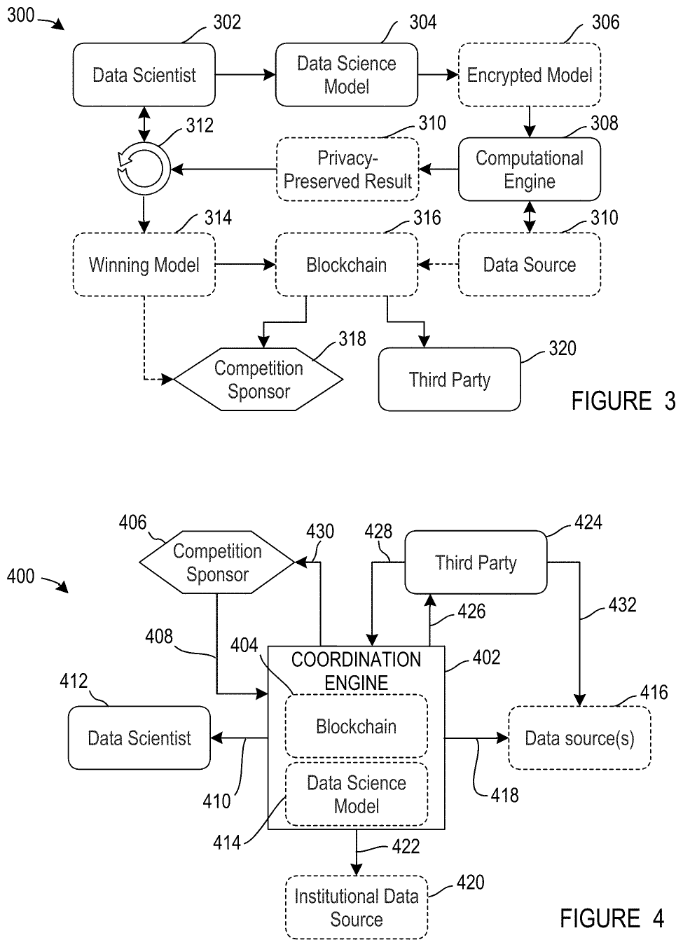

With reference now to FIG. 3, and in accordance with various embodiments, an overview of a data transfer and/or sharing during data science competition, generally referred to with the reference numeral 300, will now be described. In this example, it is presumed that a data science competition has been submitted and configured by a competition sponsor, as described above. Again, a data scientist 302 may, given the competition configuration, including any sample training data, provide a data science model 304 as an entry in the competition. In accordance with various embodiments, the data science model may then be encrypted 306, such that only the data scientist 302 is able to access details of the model (e.g. specific calculations to be performed).

The encrypted model 306 may then, via a privacy-preserving computational engine 308, perform calculations remotely using private data from a data source 310. For instance, one embodiment relates to a computational engine 308 that may travel to a private data source 310 to perform calculations in accordance with a federated learning technique, whereby data related to the computations performed may then returned from the data source machine 308. In accordance with various embodiments, such calculations may further be performed privately, such that even a remote machine (e.g. that associated with the private data source 310) may not see the specific calculations being performed. Such private computation, also referred to herein as encrypted computation, may allow the data scientist 302 to keep calculations of their model secret, even in the foreign environment of a remote machine over which they have no control. It will be appreciated that various means known in the art may be employed to perform such encrypted computation, non-limiting examples of which may include PyTorch™ and/or Tensorflow™ processes operable to execute computations in an encrypted state.

Further, it will be appreciated that various embodiments relate to an encrypted computation process enabling multi-party encrypted computation. For example, a data science model 304 may be developed by a plurality of data scientists 302. In accordance with some embodiments, such a multi-party model 304 may allow individual data scientists 302 to share control of an encrypted model 306 without seeing the entirety of its contents, such that no one owner may use or train it. Similarly, a model encryption process may comprise homomorphic encryption, wherein a single-owner model may be encrypted such that an external party may further train or use the encrypted model 306 without being able to appropriate it. Accordingly, an encrypted model 306 may, in accordance with various embodiments, remain under the control of the appropriate developer 302.

Data transfer 300 may then continue with the return of a privacy-preserved result 310 to, for instance, a server hosting the competition. The privacy-preserved result 310 may comprise, for instance, feedback on the data science model 304 with respect to its performance with real and private and/or encrypted data 310, and may include, for instance, statistical metrics with respect to model performance in view of the competition configuration. During a competition, a data scientist 302 receives such feedback via, for instance, a UI associated with the host server and/or coordination engine associated therewith, and thereby improves the model via, for instance, model iteration 312. For instance, upon feedback 310, the data scientist 302 may resubmit an improved model 304, which may again be tested on private data 310 to provide a new, possibly improved privacy-preserved result 310.

Upon completion of a data science competition, one or more winning models 314 may be determined. A winning model 314, and/or any other appropriate data related to the competition process, such as privacy-preserved results, encrypted models, or the like, may be encrypted within a blockchain 316. Accordingly, competition data, including participants and their respective contributions, may be recorded in an unambiguously yet private manner such that any data and/or rights associated therewith are preserved. For example, any data provided as user-submitted private data 310 may be committed to a blockchain 316 such that there is an encrypted record of their contribution to a project. It will be appreciated that such user-submitted data, private data 310 from an institution, and/or metadata related thereto may be committed to a blockchain 316 for analysis by an authorised party, such as a computational engine 308 having the appropriate credentials to access data encrypted within the blockchain 316 or smart contract 316.

In accordance with various embodiments, data associated with a data science competition may further be accessed or returned to various parties, in accordance with a competition configuration. For example, a competition sponsor 318, having organised and/or funded a competition, may receive the rights to a winning data science model 314, and/or any privacy-preserved results associated with the competition. Similarly, depending on a competition configuration, or agreement made after a data competition has established a successful data science model, a third party 320, such as an insurance provider, a life science organisation, a hospital, a doctor, or the like, may lease or otherwise acquire use of a model. For example, an insurance provider 320 may acquire a license from, for instance, the competition sponsor 318 to use a winning data science model 314 for private use. In accordance with some embodiments, such a licensed or otherwise accessed data model may remain encrypted, such that a third party 320 may use, but not appropriate, a proprietary product owned or shared by other entities. It will be appreciated that such transactions may similarly be recorded in a smart contract or blockchain 316.

Various embodiments of a digital platform for performing community-based data science may encourage participation and model success through the provision of various incentives. Accordingly, FIG. 4 schematically illustrates various forms of incentivisation with respect to different participants of a digital data science platform, in accordance with various embodiments. In the example of FIG. 4, the exemplary incentivisation network 400 may comprise various forms of incentives, non-limiting examples of which may include monetary compensation (e.g. physical or digital currency, such as a cryptocurrency or (non) fungible token associated with a blockchain, or the like), access to data and/or models, or the like. For illustrative purposes, the incentivisation network 400 of FIG. 4 may be described with respect to an exemplary data science competition related to the establishment of a predictive machine learning model for forecasting retention in view of biometric data accessed and analysed in accordance with privacy-preserving and encryption processes.

As described above, a data science tournament may begin with the submission of a competition configuration to a host server, or, in accordance with various embodiments, a computing machine or digital process of a coordination engine 402. A coordination engine 402 may, for instance, be in networked communication with a blockchain 404, as well as be in networked communication with various participants or computing devices associated with a data science competition (e.g. digital wallets, a network of host servers, computer nodes, or the like). For example, participants may interact or participate within a competition via a UI (e.g. web browser or digital application) associated with the coordination engine 402. The competition may be configured by a competition sponsor 406 (e.g. a ministry or health) who in accordance with a particular objective (e.g. predicting retention in view of various biomarkers), may offer a monetary reward 408 for participants in accordance with a defined distribution regime. For example, a designated portion of the monetary reward 408 may be distributed 410 to the data scientist 412 who developed the winning data science model 414. Similarly, a participant 416 providing data may be awarded a portion of the sponsored reward 408 for the provision of their private biomarker data (e.g. mood, diet, exercise, or the like).

For example, the data science competition may use the predictive machine learning model training and/or evaluation of biomarker data submitted via a smartphone application by individual users 416. User data and/or metadata related to a user's contribution may be recorded in the blockchain 404. Upon completion of the tournament (e.g. upon determination of winning model 414, or upon licensing of winning model 414), users 416 whose data contributed to model generation may receive a monetary compensation 418 or credit 418 for their data contribution. Similarly, a larger organisation(s) 420, such as a research institution 420 and/or hospital 420 contributing datasets to the development of successful models may be compensated 422 in the form of a commission 422 for their contribution of private data. In accordance with various embodiments, a contributing institution 420 may additionally or alternatively be incentivised to contribute by receiving access 422 to (e.g. free use 422 of) a successful model 414 for, for instance, subsequent research and/or patient assessment.

The establishment of generalised data science models, in accordance with various embodiments, may be further beneficial to various third-party organisations 424, such as a pharmaceutical company 424 and/or health insurance broker 424 may receive access 426 to a successful retention model 414 in accordance with a licensing agreement upon completion of a data science tournament. For example, an insurance company 424 may pay 428 for the right to access a data model 414, a portion of the proceeds of which may in turn be returned 430 to the entity 406 sponsoring the data model 414. Similarly, such licensing fees may be distributed to various participants contributing the licensed model 414, such model developer 412 and/or data sources 416 and 420. For example, an outside organisation may pay for the right to use a winning data science model 414. A value of such licensing may, in accordance with some embodiments, be further transferred to various participants associated with a data competition. For example, a competition configuration entity (e.g. the competition sponsor 406) may establish at the outset of a competition that a competition winner may receive a designated compensation (e.g. an amount of money or cryptocurrency) each time a model is leased or otherwise used. A portion of the licensing value may further be apportioned to any patients and/or hospitals that have provided data for the competition.

In accordance with yet other embodiments, a third party 424, such as an insurance company 424, may license 426 a data model to inform insurance policy decisions. For example, some embodiments relate to the use of a data science model 414 by an insurance organisation 424 to reward 432 individual users submitting health data. In such an embodiment, a user 416 may periodically or regularly submit biomarker data (e.g. answer health-related questions, submit biometrics and/or behavioural data, or the like) via a digital application for analysis by the insurance agency 424 in return for a monetary reward 432 or credit 432. For instance, the insurance agency 424 may offer reduced prices 432 for healthy behaviour as determined by a licensed health model 414, and/or return monetary or other compensation 432 (e.g. fiat currency, a cryptocurrency, or the like), for the provision of personal data.

A health data science platform may provide numerous benefits to users in addition to or as an alternative to monetary compensation. For instance, the establishment of generalised and/or accurate health data science models, coupled with user participation in a digital environment, may enable avenues to promote healthy user behaviour and health monitoring, while simultaneously improving health data collection, in accordance with various embodiments.

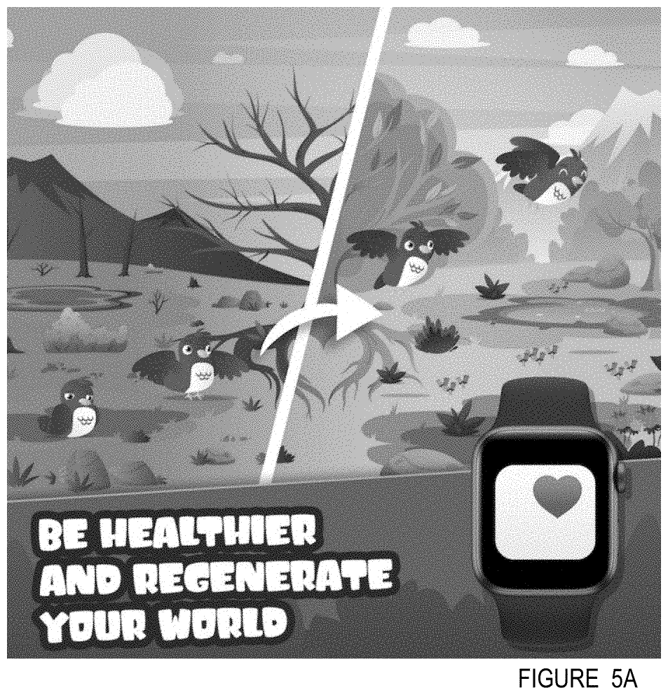

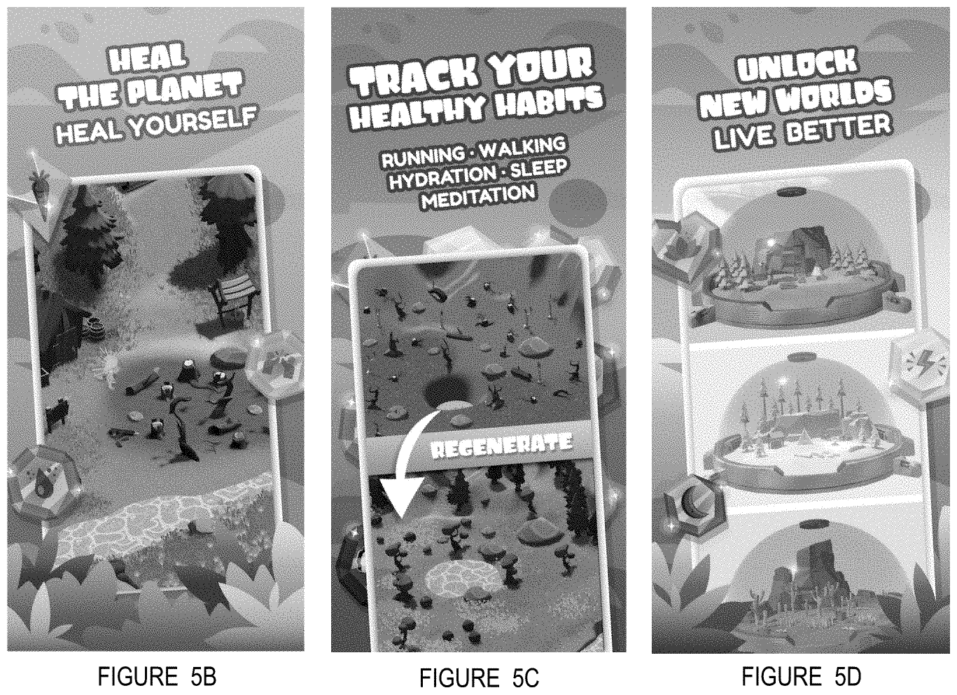

For instance, traditional means of collecting data for digital health applications, such as two-dimensional surveys, lack entertaining elements, which may lead to user fatigue and an eventual lack of participation as users become overloaded with surveys. Various embodiments contemplated herein thus relate to a digital platform for improving health data collection and general user health through the gamification of user data submission and evaluation. For example, FIGS. 5A to 5D show exemplary graphical interfaces representing a digital application (e.g. a smartphone application game) in which users may repair and/or maintain an in-game environment by exhibiting healthy real-world behaviour, and submitting data related thereto to a digital health science platform. Accordingly, such embodiments may, for instance, relate to a 3D gaming environment in which users are encouraged to submit biomarker data (e.g. water intake, nutritional data, activity, or the like), upon which they are rewarded via an in-game mechanic. Such systems may, in some embodiments, further be remotely supervised, informed, or mediated by, an healthcare professional (HCP) or organisation. Further, in some embodiments, the establishment of which health metrics are to be submitted, the equations governing in-game health scores, or the like, may be informed by, for instance, data science models established from a data science competition, and/or by a medical practitioner supervising behaviour (e.g. in view of a suspected or identified condition or recommendation, or the like).

Additionally, or alternatively, such data may also be used for subsequent data science model tournaments, or to improve established models. For example, and without limitation, users of a digital health platform may be asked to submit images of the performance of an activity (e.g. drinking water), which may be privately accessed by data science models, machine learning processes, or artificial intelligence systems for system training and/or model improvement. Meanwhile, such a platform may further benefit other participants, such as healthcare providers, insurance agencies, or the like, who may use data and/or models generated therefrom to better inform healthcare practices and/or policies.

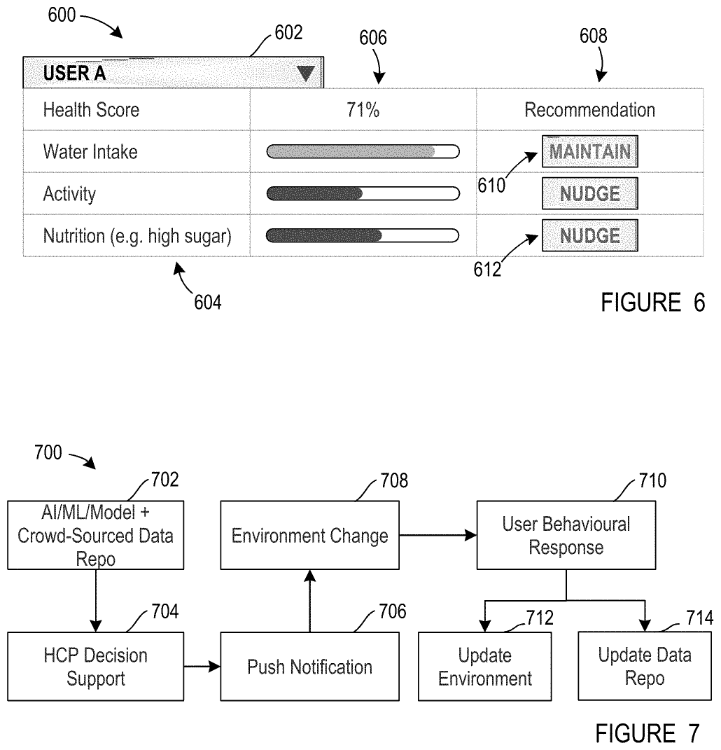

In addition to providing an entertaining experience for users, various embodiments relate to the provision of health data that may, for instance, be used by a health data science platform to improve health science models (e.g. a digital platform for performing community-based data science competitions to improve health data science models), and/or be reviewed by a healthcare practitioner (HCP) to, for instance, monitor user metrics and/or provide recommendations. For example, and in accordance with one exemplary embodiment, FIG. 6 shows and exemplary dashboard 600 associated with a digital health platform with which an HCP may interact. On the dashboard 600, an HCP may, for instance, select a user via a drop-down menu 602, whereby they may view various biomarker categories 604 and corresponding metrics and/or scores 606 for the selected user. In accordance with some embodiments, an HCP may, upon evaluation of biomarker data, provide a recommendation 608 for the user. For instance, a user may exhibit healthy behaviour with respect to one health category 604, whereby the HCP may opt to perform no action, or recommend that the user maintain 610 a current behaviour with respect to that category. Conversely, where a user is deficient in exhibiting a particular healthy behaviour, the HCP may opt to provide a notification or nudge 612 to the user. Such a notification may, in accordance with some embodiments, alert the user via a user interface or game screen that action is to be taken with respect to a particular health metric. Such recommendations 608 may therefore, in accordance with some embodiments, result in a digital workflow for the user that may be reflected in a gaming experience.

For example, with reference again to the exemplary game interface of FIGS. 5A to 5D, an in-game displayed environment may be reflective of user behaviour. For instance, and in accordance with one embodiment, a displayed environment may appear to become dry, fauna may appear sad or leave the environment, or the like, if it is determined that a user is not drinking enough water. As a response, a user may then submit data related to a water intake. For example, and without limitation, a user may then take a picture of themselves drinking water and submit the picture to the platform for, for instance, processing by an artificial intelligence or machine learning process in a federated learning environment, as described above. Upon determination of the user's healthy behaviour, the in-game environment may then be updated, for instance by displaying happier fauna or a healthier environment.

In accordance with one such embodiment, FIG. 7 diagrammatically illustrates an exemplary process 700 by which a digital health data science platform may promote healthy user behaviour and health monitoring, while simultaneously improving health data collection for data science model generation. In this example, the digital platform may access a repository of crowd-sourced user data (e.g. biomarkers submitted to the platform and encrypted in accordance with a smart contract) and a data science model (e.g. a winning health model from a data science competition, as described above), the combination 702 of which may return processed data to an HCP 704 to improve or otherwise inform recommendations with respect to user health metrics. The HCP may then push any recommendations or notifications 706 to a user device, which may be displayed as, for instance, an environmental change 708 in the user's game interface. The user may then exhibit or submit a behavioural response 710, whereby the in-game environment may be updated 712. The user response may then further be utilised to update the repository of health data 714 from which data science models may be trained and/or improved, such as in a subsequent community-based health data science tournament.

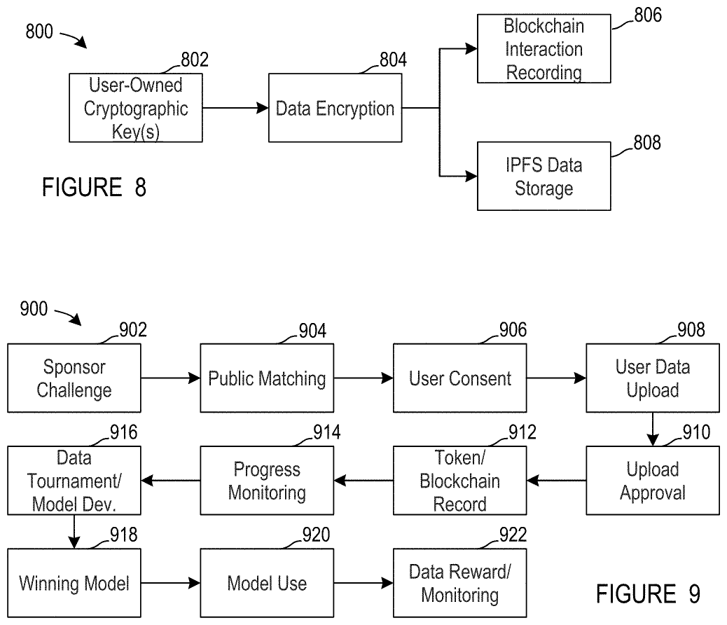

In order to provide and store such data in a secure fashion, FIG. 8 schematically illustrates an exemplary secure data flow 800, in accordance with one embodiment. In this example, a user is in possession of a secure and/or private encryption key 802 (e.g. a cryptographic key 802). Using this private key, the user may then encrypt 804 any or all data to be provided within the context of a privacy-preserving health data science platform, for instance via a digital application on a user-associated device (e.g. a mobile phone). Any interactions (e.g. digital handshakes, transactions, data contributions, etc.) associated with the user may then be stored/recorded on a blockchain 806, while any information related to or provided by the user may be stored in an encrypted and secure fashion, for instance in an IPFS container 808.

Having a means of providing secure and private data, as, for instance, schematically illustrated in FIG. 8, a user may participate within a data science competition within one or more contexts. For example, FIG. 9 is a diagram of an exemplary process flow 900 showing various aspects of a health data science competition, in accordance with one embodiment. In this example, a competition may begin with the sponsorship of a challenge 902 (e.g. a life science organisation may sponsor a challenge for a particular data science application of interest). Public matching 904 with the sponsored challenge 902 may then be performed. For example, the challenge may be publicly posted such that a browsing user may view the challenge and details associated therewith (e.g. types of data requested, amount of data still required in an open challenge data pool, or the like) and opt to participate. Additionally, or alternatively, a data science platform or service may ‘match’ potential participants based on shared data or preferences, based on, for instance, the type of data requested for a challenge. For example, a service may notify one or more specific users through a digital application associated therewith to the opportunity to participate in a challenge based on stored user preferences, in accordance with one embodiment.

Should a user agree to participate in the challenge, their consent 906 to do so may then by obtained, which may then enable the user to upload any data 908 to the platform, based on their selected role in the challenge (e.g. providing health-related data, data science models, or the like). In accordance with some embodiments, uploaded data 908 may be subject to an approval process 910, wherein, for instance, a quality assurance user (e.g. a researcher, a health expert, or the like) may verify the suitability of data provided. Upon approval, the user providing data may receive confirmation of the same, with their participation being recorded 912. For example, the data-providing user may receive a digital token or blockchain entry 912 recording, for instance, the nature of their participation.

Upon data submission for the challenge, the user may then monitor progress 914 of the challenge, for instance via a digital application linking the user to one or more challenges with which they are associated. The challenge may further proceed, wherein, for instance, a data science model tournament is executed to develop a machine learning model 916 using the data pool provided for the challenge. Upon identification of a winning data science model(s) 918, the model(s) may be used 920 as defined in the challenge configuration, for instance by the challenge sponsor 902. Participating users (e.g. contributed data to a pool, provided a winning model, or the like), may subsequently monitor use 922 of a model developed based at least in part on their participation, and/or earn rewards and/or incentives 922 based on that use, for instance via licensing of a winning model associated with the smart contract within which their participation is recorded 912.

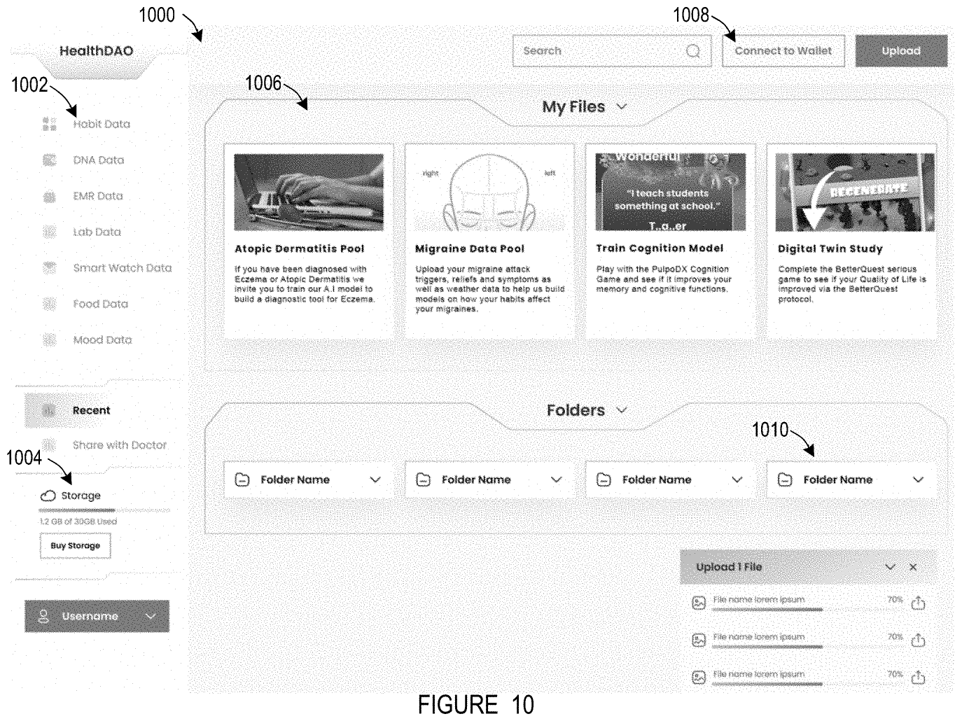

In accordance with some embodiments, such participation within a health data science platform may be provided via graphical interface. For example, FIG. 10 is an exemplary dashboard 1000 providing access for a user to a health data science platform. In this example, the dashboard 1000 provides access to a number of devices or sources 1002. For example, the user may have associated with their platform account a number of devices tracking various aspects of their behaviour, such as a smart watch, step counter, or tracker of various other biometrics or biomarkers. Similarly, the dashboard 1000 may allow access to various health-related profiles, such as user-entered food, mood, or habit datasets. The platform may also connect user profiles with external data sources, such as EMR data, lab data (e.g. blood tests, or the like), DNA sequencing profiles, or the like.

The exemplary dashboard 1000 of the FIG. 10 further provided the user with the ability manage how their data is stored 1004. For example, in accordance with one embodiment, the user may opt to keep their data unshared, storing up to a designated amount of data privately, with the option to purchase additional storage space. Conversely, they may opt to share their data, which may enable an increased amount of storage space without cost.

The dashboard 1006 further provides the user with a view of challenges 1006 in which they may have interest and/or participate. Such open challenges 1006 may relate to, for instance, incentives earnable by the user for their participation, such as cryptocurrency or fiat currency rewards, or another incentive related to an innovation arising from their participation, such as a right to earn royalties or licensing fees for a data science model provided by the user. Such incentives may be coordinated and/or linked with a digital wallet 1008 associated with the user, such as, without limitation, a Web3 wallet ‘metamask’, and/or a self-sovereign blockchain connection.

The dashboard 1000 further allows the user to organise their health data in, for example, folders 1010, as well as allowing the user to customise and/or enable settings associated with their profile, such as settings related to matching processes for linking the user with certain challenges or challenge types.

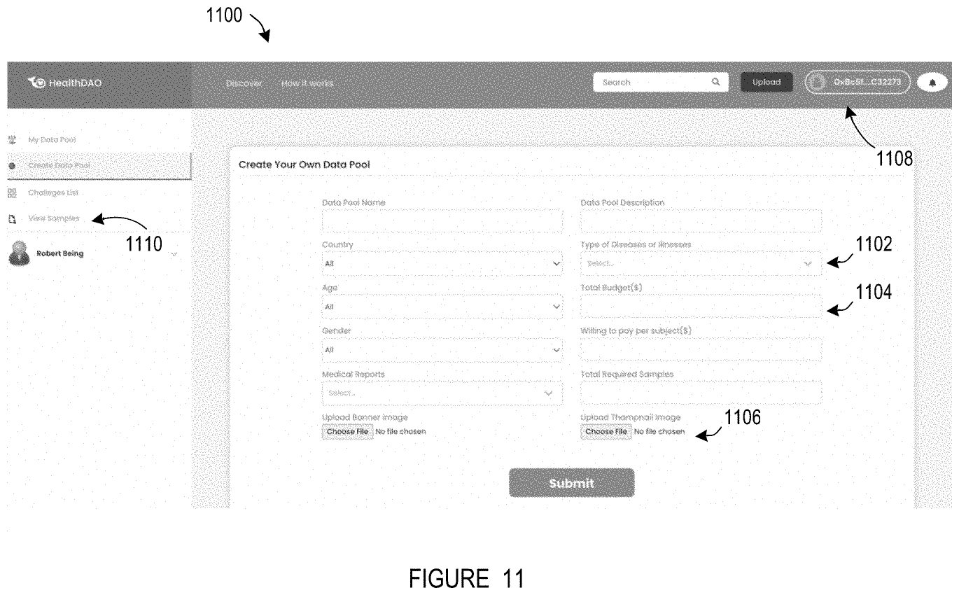

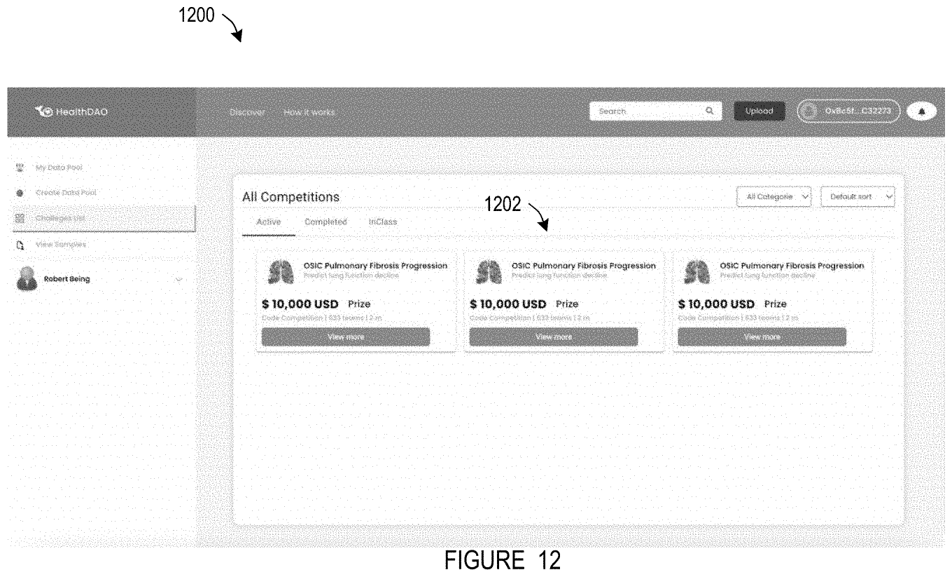

Various such dashboards may be provided to link users within the context of a digital health science data platform depending on, for instance, their role in association with a challenge or competition, in accordance with various embodiments. For example, FIG. 11 is another exemplary dashboard 1100 from which a user may configure various aspects of a digital health data science competition, in accordance with one embodiment. In this example, the dashboard 1100 allows the user to create a challenge targeting users with a designated medical condition 1102, as well as to set a challenge budget 1104. The challenge may further be configured in accordance with a designated legal conditions 1106, such as defined licensing rights that may result from the challenge. In this example, the dashboard 1100 further provides access to a blockchain wallet 1108. For instance, a challenge creator may be authorised via a smart contract, or voted by a community as an authorised creator, in order to log in as such via a blockchain wallet 1108. In this example, the user may further view various aspects associated with their account, such as via a ‘View Samples’ interface selectable from the dashboard 1100. In the context of a challenge creator, this may enable viewing of health data samples submitted and/or purchased 1110 for one or more challenges.

While the dashboard 1100 generally relates to the creation of a data science challenge by a particular user, FIG. 12 is another dashboard 1200 accessible to the user for viewing challenges/competitions with which they are associated. In this example, the user may view active, completed, or otherwise defined challenges. For example, a challenge may be viewable as ‘Active’ 1202 once the defined amount of data is collected, whereby data scientists may view such challenges and commence the development of machine learning models therefor.

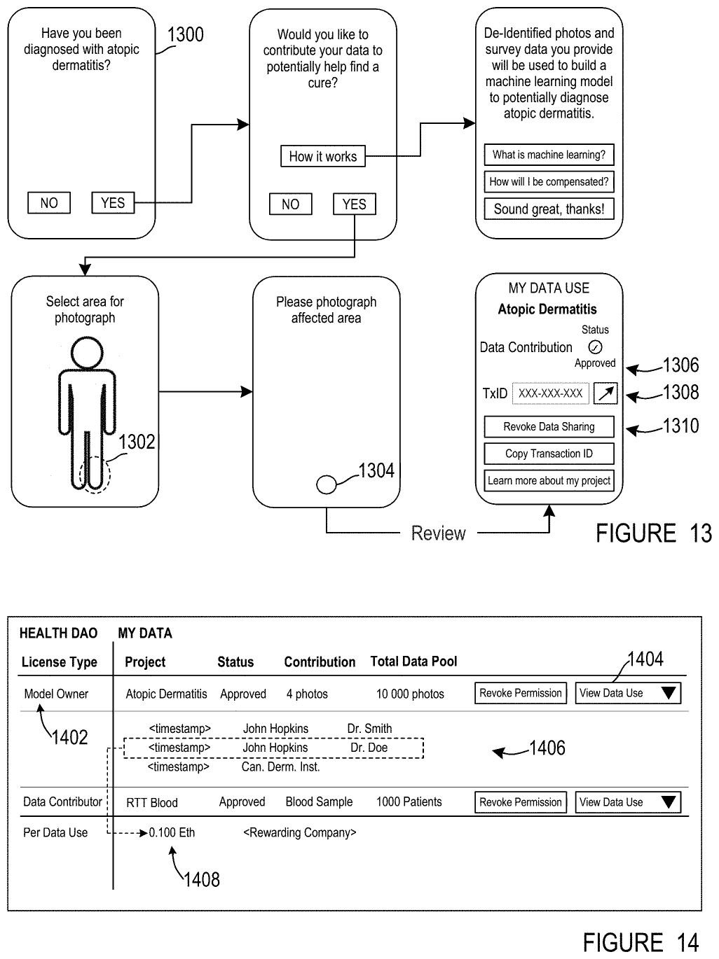

With respect to the submission of health-related data, it will be appreciated that various means may be employed, in accordance with various embodiments. For example, as described above with respect to FIG. 10, a user may connect various devices or data sources 1002 with a user profile, and choose how such data is shared. However, in accordance with one embodiment, FIG. 13 schematically illustrates one exemplary means by which a user may submit health data via a digital application on a mobile phone 1300.

In this non-limiting example, a user may log in to a digital application associated with a health-based data science platform, and select or be presented with the option to participate in a designated study or challenge. In the example of FIG. 13, which schematically illustrates one exemplary flow of user participation using a mobile device 1300, the challenge is related to the generation of a data science model for assessing atopic dermatitis, wherein the user is prompted with a series of questions, options, and functionalities associated with the submission of data. In this case, the user is first asked if they are experiencing atopic dermatitis, to which they may select appropriate responses within the digital application.

The flow diagram of the exemplary embodiment of FIG. 13 continues with appropriate prompts related to previous user selections. For instance, should the user be appropriately diagnosed with the condition, they may be asked about their willingness to provide data for model generation, with the option to be provided with additional information, to decline, or to accept. Should they accept, the user may then be asked to provide a general description of the affected area. This may be useful to, for instance, provide additional data for model generation, and/or to screen for potential privacy-related issues. For example, should the user be affected in a region near their face, they may be screened from further participation due to the risk of being identifiable from images submitted of the area of their body affected by atopic dermatitis. Similarly, other regions of the body may be sensitive in nature, which may be precluded from further analysis to maintain user privacy, depending on the nature and configuration of the data science challenge.

In the example of FIG. 13, the user identifies that they are affected on the lower region 1302 of their left leg, which leads to an invitation to acquire a photograph of the affected region. Upon capture of the image by engaging a camera button 1304 of the digital application, the image and/or other data may be subject to a review process, wherein the data is evaluated for, for instance, suitability for data science model generation, for instance by a quality assurance user, medical professional, or the like.

Upon submission of health data, the user may review various aspects of their submission, or indeed various aspects related to other submissions or participation, via the mobile application. For example, in FIG. 13, the user may see via their device 1300 a submission status 1306 related to the acceptability of their data contribution. While the example of FIG. 13 shows that data was approved, they may, depending on the status of, for instance data review, they may be presented with icons and/or information related to a pending status, declined status, or the like. The user may further be presented with options related to the sharing 1310 of their submitted data, whereby they may revoke or enable data sharing. Further, the digital application may display information related to any transaction information related to their data, such as a transaction ID number linking their participation to a blockchain, as well as be presented with the option or a link 1308 to view submission data via a browser or other medium, such as a block explorer or health data science platform interface.

For example, FIG. 14 is a schematic of an exemplary dashboard by which a user may view aspects related to their data across multiple submissions. In this example, the user is provided a view of all health data contributions made, grouped by the license type 1402 associated with each submission. The user may further view a status and potential payments associated with each submission, and be provided with the option to revoke any data permissions. For example, FIG. 14 shows a first submission in which the user is has submitted four photographs for a data science competition related to atopic dermatitis. Based on the license type 1402 associated with the competition, the user was granted partial ownership of the resultant model, and was thereby designated as a machine learning model owner. The user may further select an icon 1404 to provide a timeline 1406 associated with their contribution, in this case a list of instances 1406 in which their data was accessed (e.g. a timeline of respective viewings of their submitted images, uses of the resultant model, or the like). By selecting an instance of use in the list 1406, the user is then provided with information related to an incentive 1408 provided for that data contribution, such as monetary and/or cryptocurrency reward per instance of use of their data.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A system for performing incentivised community-based privacy-preserving data science, the system comprising:
a coordination engine governing a digital environment for hosting respective data science competitions across a distributed network of computational machines, wherein said digital environment is configured to receive from each given competition submission entity configurational data related to a given competition configuration, and receive from each respective competition participant a respective data science model comprising respective computationally-executable instructions;
a privacy-preserving execution engine configured to remotely access private data related to each said given competition configuration from a private data source, and operable to, for each said respective data science model:
encryptically execute said respective computationally-executable instructions on said private data; and
return a privacy-preserved result of said encryptically executed computationally-executable instructions in accordance with a designated privacy-preserving process;
wherein said coordination engine is further configured to:
based at least in part on said privacy-preserved result for each said respective encrypted data science model, assess a winning data science model in accordance with said given competition configuration; and
encryptically store said winning data science model.

2. The system of claim 1, wherein said private data source comprises private data related to a plurality of individuals.

3. The system of claim 1, wherein said private data source comprises individual user data submitted in accordance with an encryption process.

4. The system of claim 3, wherein said individual user data is managed via a smart contract.

5. The system of claim 1, wherein said given competition configuration comprises an incentive distributable by said coordination engine.

6. The system of claim 5, wherein said incentive comprises a cryptocurrency.

7. The system of claim 5, wherein said incentive is contributed by one or more of said given competition submission entity or a third-party organisation.

8. The system of claim 5, wherein at least a portion of said incentive is distributed to one or more of a winning competition participant, said private data source, or said competition submission entity.

9. The system of claim 8, wherein said incentive comprises one or more of a monetary incentive or an access right to said winning data science model.

10. The system of claim 1, wherein said designated privacy-preserving process comprises a differential privacy process.

11. The system of claim 1, wherein said privacy-preserving execution engine is operable to encryptically execute said respective computationally-executable instructions in accordance with one or more of a homomorphic encryption process, a multi-party encrypted computation process, a federated learning process, or an on-device prediction process.

12. The system of claim 1, wherein said given competition configuration comprises model training data.

13. The system of claim 1, further comprising a distributed ledger, and wherein said coordination engine is further operable to record transactional data in said distributed ledger.

14. The system of claim 1, wherein said private data comprises health data.

15. The system of claim 1, wherein said coordination engine comprises one or more of a host server or a server network.

16. The system of any one of claim 1, wherein said respective data model comprises a respective encrypted data science model.

17. A computer-implemented method for performing incentivised community-based privacy-preserving data science, the method comprising:
receiving from each given competition submission entity configurational data related to a given competition configuration;
receiving from each respective competition participant a respective data science model comprising respective computationally-executable instructions;
remotely accessing private data related to each said given competition configuration from a private data source, and, for each said respective data science model:
encryptically executing said respective computationally-executable instructions on said private data; and
returning a privacy-preserved result of said encryptically executed computationally-executable instructions in accordance with a designated privacy-preserving process; and
based at least in part on said privacy-preserved result for each said respective encrypted data science model:
assessing a winning data science model in accordance with said given competition configuration; and
encryptically storing said winning data science model.

18. The method of claim 17, further comprising encrypting one or more of said respective data science model or said private data.

19. The method of claim 17, further comprising encryptically storing transactional data associated with said given competition configuration.

20. The method of claim 19, further comprising compensating with an incentive one or more users associated with said given competition configuration based at least in part on said transactional data.
